(19) United States
(12) Patent Application Publication
(10) Pub. No.: US 2002/0150364 A1
(43) Pub. Date: Oct. 17, 2002

(54) Single mode fibre

(76) Inventors: Ian Bassett, Wollstonecraft (AU); John Canning, Sydney (AU)

Correspondence Address: Stephen A. Bent, FOLEY & LARDNER, Washington Harbour, 3000 K Street, N.W., Suite 500, Washington, DC, 20007-5109, US

(21) Appl. No.: 09/825,362

(22) Filed: Apr. 4, 2001

(51) Int. Cl. G02B 6/16

(52) U.S. Cl. 385/123; 385/37

(57) ABSTRACT

An optical fibre adapted in a manner such that it guides an optical signal substantially only in one non-degenerate mode.

### FIELD OF THE INVENTION

The present invention relates broadly to an optical fibre and to a method of fabricating an optical fibre. The invention further relates to a device and method for generating an optical signal for propagation in the optical fibre.

### BACKGROUND OF THE INVENTION

Conventional “single” mode (SM) fibres are not true single mode fibres. This is because in conventional SM fibres the supported mode is the HE11 mode. The HE11 mode is 2 fold degenerate, corresponding to the two possible polarisations of the light wave in that mode. Polarisation is a disadvantage in most applications of optical fibres, both in telecommunications and in sensing. In telecommunications, polarization mode dispersion is one of the significant limiting factors encountered in data transmission in conventional SM fibres. In sensing employing interferometry, polarisation control must be exercised, or the sensitivity will fluctuate unpredictably, a form of “signal fading”.

In at least one of the preferred embodiments, the present invention seeks to provide a “true” single mode optical fibre, thereby e.g. eliminating the disadvantages associated with polarisation mode dispersion in data transport and signal fading in interferometry,

### SUMMARY OF THE INVENTION

In accordance with a first aspect of the present invention there is provided an optical fibre adapted in a manner such that it guides an optical signal substantially only in one non-degenerate mode.

Preferably, the non-degenerate mode is the TE01 mode.

In one embodiment, the optical fibre comprises a central hole region along its length, a concentric guiding region around the hole region, and a cladding region around the guiding region, wherein the diameter of the hole region, the thickness of the guiding region, the refractive index of the guiding region, and the refractive index of the cladding region are chosen such that, in use, only the one non-degenerate mode is guided in the guiding region.

Preferably, the diameter of the hole region the thickness of the guiding region, the refractive index of the guiding region, and the refractive index of the cladding region are chosen such that, in use, an effective refractive index for the HE11 mode of the optical signal is reduced to be equal to or below the refractive index of the cladding region, whereby the HE11 mode is radiated away from the guiding region.

The refractive index of the guiding region and/or the cladding region may be graded.

In an alternative embodiment, the optical fibre comprises a concentric Bragg reflector region around a guiding region of the optical fibre, wherein the Bragg reflector region is arranged in a manner such that, in use, least leaking into the cladding region is experienced by the TE01 mode, whereby substantially only the TE01 mode is guided in the guiding region.

The optical fibre in such an embodiment may comprise a photonic crystal fibre.

The optical fibre in such an embodiment may further comprise a central hole region arranged in a manner such that an effective refractive index for the HE11 mode of the optical signal is reduced to be equal to or below the refractive index of the cladding region, whereby the HE11 mode is radiated away from the guiding region to assist suppressing guiding of the HE11 mode in the guiding region.

In yet another alternative embodiment, the optical fibre may comprise absorption means adapted to preferentially absorb light in modes other than the one non-degenerate mode. The optical fibre in such an embodiment may further comprise amplifying means adapted to amplify substantially only the one non-degenerate mode. The absorption means and/or the amplification means may comprise regions of the optical fibre made from a suitable optically absorbing or amplifying material respectively.

In accordance with a second aspect of the present invention there is provided a method of manufacturing an optical fibre, the method comprising the step of selecting design parameters in the manufacture of the optical fibre in a manner such that the optical fibre guides an optical signal substantially only in one non-degenerate mode.

Preferably, tile non-degenerate mode is the TE01 mode.

In one embodiment, the method comprises the step of selecting the diameter of a central hole region of the fibre, the thickness of a concentric guiding region of the fibre around the hole region, the refractive index of the guiding region, and the refractive index of a cladding region of the fibre around the guiding region such that, in use, only the one non-degenerate mode is guided in the guiding region.

Preferably, the diameter of the bole region, the thickness of the guiding region, the refractive index of the guiding region, and the refractive index of the cladding region are selected such that, in use, an effective refractive index for the HE11 mode of the optical signal is reduced to be equal to or below the refractive index of the cladding region. whereby the HE11 mode is radiated away from the guiding region.

The refractive index of the guiding region and/or the cladding region may be graded.

In an alternative embodiment, the method comprises the steps of selecting a Bragg reflector region of the fibre around a guiding region of the fibre and arranged in a manner such that, in use, least leaking into a cladding region of the fibre around the Bragg region is experienced, in use, by the TE01 mode, whereby substantially only the TE01 mode is guided in the guiding region

The optical fibre in such an embodiment may comprise a photonic crystal fibre.

The method in such an embodiment may further comprise the step of forming a central hole region in the optical fibre and arranged in a manner such that an effective refractive index for the HE11 mode of the optical signal is reduced to be equal to or below the refractive index of the cladding, whereby the HE11 mode is radiated away from the guiding region to assist suppressing guiding of the HE11 mode in the guiding region.

The method in yet another alternative embodiment may comprise the steps of providing absorption means associated with the optical fibre and adapted to preferentially absorb light in modes other than the one non-degenerate mode. The method in such an embodiment may further comprise the step of providing amplifying means associated with the optical fibre and adapted to amplify substantially only the one non-degenerate mode. The absorption means and/or the amplification means may comprise regions of the optical fibre made from a suitable optically absorbing or amplifying material respectively.

In accordance with a third aspect of the present invention there is provided a light source structure adapted in a manner such that it generates a light signal which comprises substantially only one non-degenerate mode

Preferably, the light source structure comprises an optical fibre laser, wherein the optical fibre laser comprises an optical fibre as defined in the first aspect of the present invention.

In accordance with a fourth aspect of the present invention there is provided a method of generating a light signal which comprises substantially only one non-degenerate mode.

Preferably, the method comprises the step of effecting lasing to occur in an optical light source structure as defined in the third aspect of the present invention.

### BRIEF DESCRIPTION OF THE DRAWINGS

Preferred forms of the present invention will now be described, by way of example only, with reference to the accompanying drawings.

FIG. 1 shows a plot of the intensity of different modes of propagation of an optical signal travelling in a typical radially symmetric waveguide as a function of radius r.

FIG. 2 is a schematic cross sectional view of an optical fibre embodying the present invention.

FIG. 3 is a schematic cross sectional view of another optical fibre embodying the present invention.

FIGS. 4(A), (B) & (C) are schematic diagrams illustrating a manufacturing process for an optical fibre embodying the present invention.

FIG. 5 is a schematic cross sectional view of another optical fibre embodying the present invention.

FIG. 6 is a schematic cross sectional view of another optical fibre embodying the present invention.

FIG. 7 is a schematic diagram illustrating an optical fibre laser arrangement embodying the present invention.

### DETAILED DESCRIPTION OF THE PREFERRED EMBODIMENTS

The preferred embodiments described provide an optical fibre adapted in a manner such that it guides an optical signal substantially only in one non-degenerate mode.

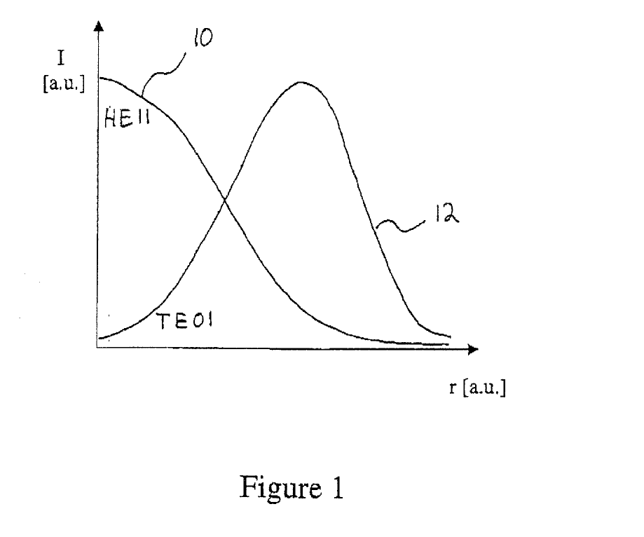

FIG. 1 shows a plot of the intensity of different modes of propagation of an optical signal travelling in a radially symmetric waveguide as the function of the radius r. As can be seen from FIG. 1 the intensity curve for the highest mode HE11, curve 10, has a maximum at the centre of the waveguide. In contrast, the curve for what is normally the next lower mode, the TE01 mode, curve 12, has its maximum intensity in a doughnut shaped maximum around the centre of the waveguide. Importantly, the TE01 node is a non-degenerate mode, That is, in this mode the magnetic quantum number m=0. Thus a light signal that propagates only in e.g. the TE01 mode will not experience polarization mode dispersion or interferometric signal fading resulting from superposition of polarisations.

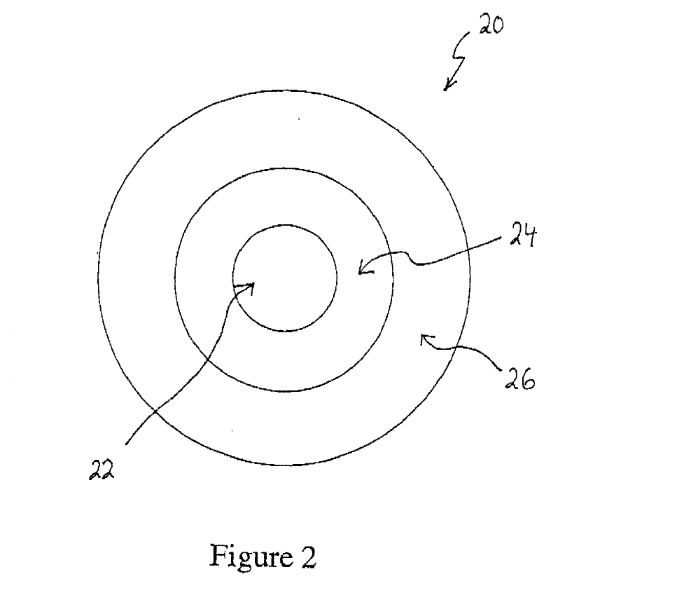

In one embodiment of the present invention illustrated in FIG. 2, an optical fibre 20 is designed having the following characteristics. It comprises a central hole region 22, surrounded by a concentric guiding region 24, which is in turn surrounded by a concentric cladding region 26.

It is the design object in the optical fibre 20 to chose the design parameters in a manner such that the effective refractive index for the HE11 mode is reduced due to the presence of the hole region 22 to a value equal to or below the refractive index of the cladding region 26. If this design condition is achieved, the HE11 mode will be radiated away from the guiding region 24 through the cladding region 26, i.e. its guided propagation along the guiding region 24 of the optical fibre 20 is suppressed.

It will be appreciated by a person skilled in the art, that through appropriate selection of the design parameters of the optical fibre 20, the presence of the hole region 22 will not significantly perturb the TE01 mode (compare FIG. 2) thus leaving the TE01 mode as the mode with the now highest effective refractive index experienced by any mode. Through suitable selection of the design parameters of the optical fibre 20 in the exemplary embodiment such that the effective refractive index experienced by all other (lower) modes will be equal to or lower than the refractive index of the cladding region 26, those modes will also be radiated away from the guiding region 24.

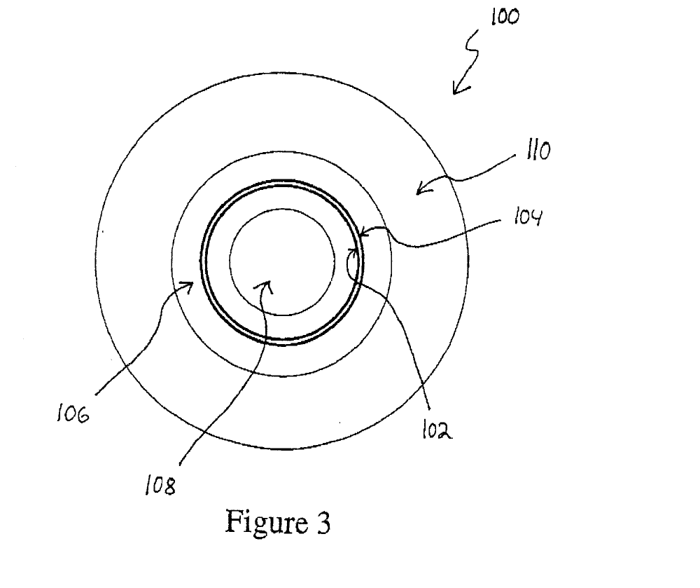

Depending on the material and/or wavelength of a light signal of interest, the effective refractive index for the TM01 mode can be close to the effective refractive index for the TE01 mode. It may then be advantageous to provide a further means for assisting the suppression of light propagation in the TM01 mode. In another optical fibre design 100 embodying the present invention shown in FIG. 3, closely spaced concentric rings 102, 104 of alternating refractive index are placed within a concentric guiding region 106 roughly where the TE01 node (and the TM01 mode) has a maximum intensity (compare FIG. 1). The fibre design 100 further comprises a central hole region 108 and a concentric cladding region 110.

In the fibre design 100, the concentric rings 102, 104 of alternating refractive index are expected, in use, to alter the effective refractive index for the TE01 mode more than for the TM01 mode. Through appropriate selection of the design parameters, the effective refractive index for the TM01 mode can be reduced relative to the TE01 mode to assist in ensuring that it is equal to or below the refractive index of the cladding region 110, which in turn ensures that the TM01 mode is radiated away from the guiding region 106.

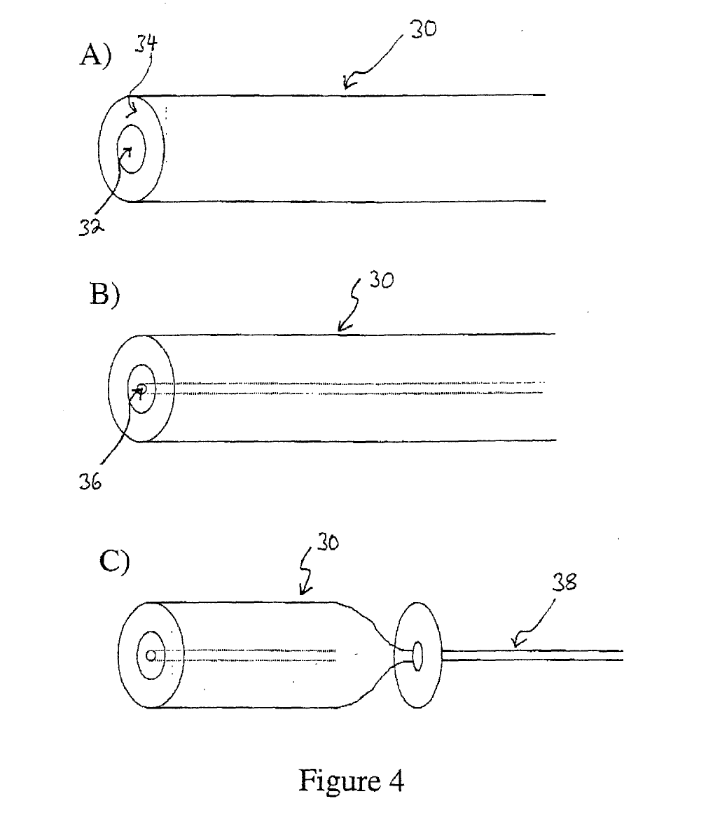

It will be appreciated by a person skilled in the art that the optical fibres 20, 100 of the exemplary embodiments can be readily manufactured utilising existing optical fibre manufacturing techniques One exemplary method of manufacturing the optical fibre 20 embodying the present invention will now be described briefly with reference to FIG. 4. In FIG. 4A, as a first step a preform 30 is manufactured utilising known techniques Such as modified chemical vapour deposition (MCVD) inside a tubular carrier member (not shown). The preform 30 has a step function in its refractive index i.e. it consists on a core region 32 and a cladding region 34 of differing refractive index.

As shown in FIG. 4B, in a next step a hole 36 is created in the preform 30 through e.g. drilling.

In a final step shown in FIG. 4C, an optical fibre 38 is drawn from the preform 30. It will be appreciated by a person skilled in the art that the design parameters of the preform 30 can be selected such that they correspond to the desired design characteristics of the optical fibre 38.

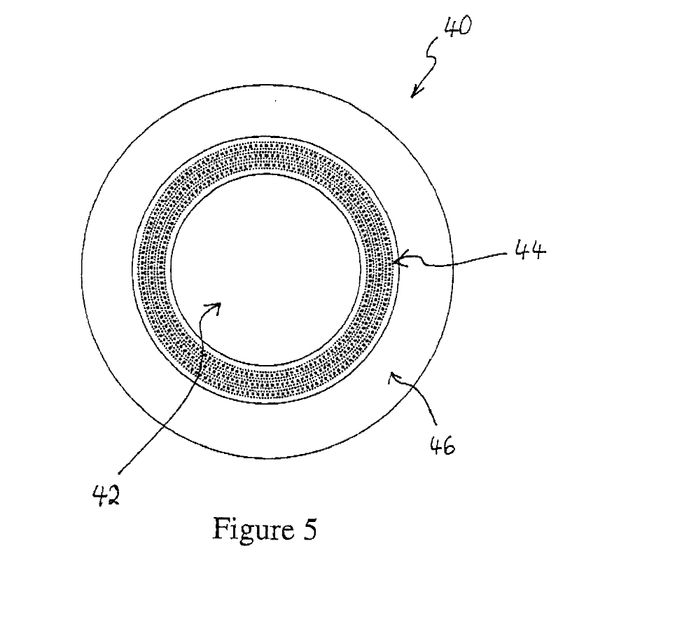

In an alternative embodiment of the present invention shown in FIG. 5, an optical fibre 40 comprises a core region 42, surrounded by a concentric Bragg reflector region 44, which in turn is surrounded by a concentric cladding region 46. The Bragg reflector region 44 comprises a refractive index profile, in an exemplary embodiment radially symmetric, which constitutes a grating structure with respects to a light signal propagated within the core region 42.

It has been found by the applicant that in the optical fibres of the design of optical fibre 40 shown in FIG. 5, the least leaking of light intensity occurs for the TE01 mode, In other words, the optical fibre 40 will preferentially guide light only in the TE01 mode, whilst suppressing the guiding of any of the other modes.

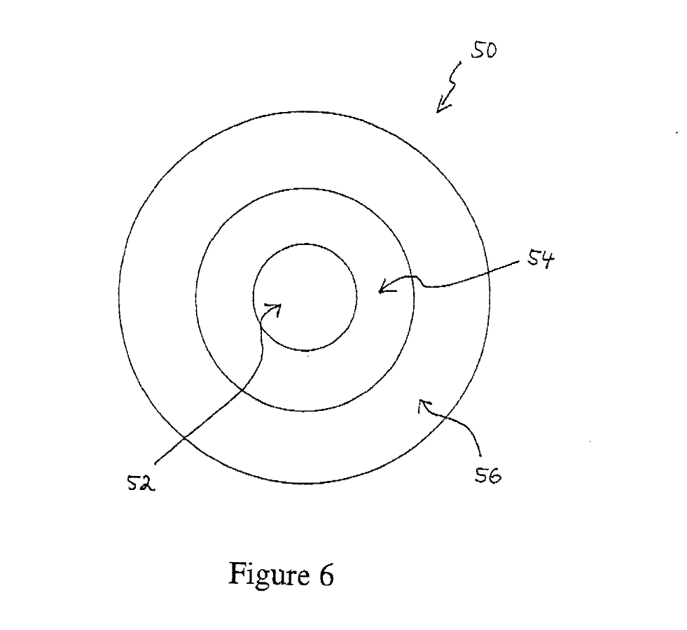

In yet another embodiment of the present invention shown in FIG. 6, an optical fibre 50 comprises a cylindrical centre region 52 surrounded by a concentric guiding region 54, which in turn is surrounded by a concentric cladding region 56.

The material of which the central region 52 is formed is chosen such that it absorbs light at the wavelength of a particular light signal intended for propagation in the guiding region 54.

It will be appreciated by the person skilled in the art that, since the HE11 mode has a maximum in its intensity at the centre of the optical fibre 50 (compare FIG. 1), this will result in preferential absorption of the HE11 node. This is in contrast with the situation for the TE01 mode (compare FIG. 1), which will experience an insignificant perturbance caused by the absorption in the centre region 52, provided that the design parameters of the optical fibre 50 are chosen appropriately.

In a modification of the optical fibre 50 shown in FIG. 6, the material of the guiding region 54 may further be chosen in a manner such that it amplifies light at the wavelength of the particular light signal, which will in effect result in preferential amplification of the TE01 mode, which his a doughnut shape maximum in its intensity in the area of the guiding region 54 (compare FIG. 1) if the design parameters chosen appropriately. This can enhance the true single mode characteristics of an optical fibre embodying the present invention.

FIG. 7 shows an optical fibre laser signal arrangement 60 embodying the present invention, The optical fibre laser arrangement 60 comprises a pump laser source 62 for pumping an optical fibre laser 64. Importantly, the optical fibre laser 64 comprises an optical fibre embodying the present invention; in the exemplary embodiment an optical fibre of the type of optical fibre 20 described above with reference to FIG. 2.

It will be appreciated by the person skilled that to construct the fibre laser 64 utilising an optical fibre of the type of optical fibre 20, e.g. a suitable dopant material is provided in the guiding region 24 (see FIG. 2) to effect lasing between reflective elements 66, 68 at end portions of The optical fibre laser 64. One of the reflective elements 66 is e.g., a semi-transparent reflective element, thus enabling emission of the TE01 laser beam 70.

It will be appreciated by a person skilled in the art that the optical fibre laser arrangement 60 is suitable for substantially direct coupling of light into optical fibre embodying the present invention, e.g., optical fibre of the type of optical fibre 20, optical fibre 100, or optical fibre 50 described above with reference to FIG. 2, FIG. 3, and FIG. 6 respectively.

It will be appreciated by the person skilled in the art that numerous modification and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. An optical fibre adapted in a manner such that it guides an optical signal substantially only in one non-degenerate mode.

2. An optical fibre as claimed in claim 1, wherein the non-degenerate mode is the TE01 mode.

3. An optical fibre as claimed in claim 1, wherein the optical fibre comprises:
a central hole region along its length,
a concentric guiding region around the hole region, and
a cladding region around the guiding region,
wherein the diameter of the hole region, the thickness of the guiding region, the refractive index of the guiding region, and the refractive index of the cladding region are chosen such that, in use, only the one non-degenerate mode is guided in the guiding region.

4. An optical fibre as claimed in claim 3, wherein the diameter of the hole region, the thickness of,the guiding region, the refractive index of the guiding region, and the refractive index of the cladding region are chosen such that,, in use, an effective refractive index for the HE11 mode of the optical signal is reduced to be equal to or below the refractive index of the cladding region, whereby the HE11 mode is radiated away from the guiding region.

5. An optical fibre as claimed in claim 3, wherein the refractive index of the guiding region and/or the cladding region is graded.

6. An optical fibre as claimed in claim 1, wherein the optical fibre comprises:
a concentric Bragg reflector region around a guiding region of the optical fibre,
wherein the Bragg reflector region is arranged in a manner such that, in use, least leaking into the cladding region is experienced by the TE01 mode, whereby substantially only the TE01 mode is guided in the guiding region.

7. An optical fibre as claimed in claim 6, wherein the optical fibre comprises a photonic crystal fibre.

8. An optical fibre as claimed in claim 6, wherein the optical fibre further comprises a central hole region arranged in a manner such that an effective refractive index for the HE11 mode of the optical signal is reduced to be equal to or below, the refractive index of the cladding region, whereby the HE11 mode is radiated away from the guiding region to assist suppressing guiding of the HE11 mode in the guiding region.

9. An optical fibre as claimed in claim 1, wherein the optical fibre comprises:
absorption means adapted to preferentially absorb light in modes other than the one non-degenerate mode.

10. An optical fibre as claimed in claim 9, wherein the optical fibre further comprises amplifying means adapted to amplify substantially only the one non-degenerate mode.

11. An optical fibre as claimed in claim 9, wherein the absorption means and/or an amplification means comprise regions of the optical fibre made from a suitable optically absorbing or amplifying material respectively.

12. A method of manufacturing an optical fibre, the method comprising the step of selecting design parameters in the manufacture of the optical fibre in a manner such that the optical fibre guides an optical signal substantially only in one non-degenerate mode.

13. An method as claimed in claim 12, wherein the non-degenerate mode is the TE01 mode.

14. An method as claimed in claim 12, wherein the method comprises the step of:
selecting the diameter of a central hole region of the fibre., the thickness of a concentric guiding region of the fibre around the hole region, the refractive index of the guiding region, and the refractive index of a cladding region of the fibre around the guiding region such that, in use, only the one non-degenerate mode is guided in the guiding region

15. An method as claimed in claim 14, the diameter of the hole region, the thickness of the guiding region, the refractive index of the guiding region, and the refractive index of the cladding region are selected such that, in use, an effective refractive index for the HE11 mode of the optical signal is reduced to be equal to or below the refractive index of the cladding region, whereby the HE11 mode is radiated away from the guiding region.

16. An method as claimed in claim 14, wherein the refractive index of the guiding region and/or the cladding region is graded.

17. An method as claimed in claim 12, wherein the method comprises the steps of:
selecting a Bragg reflector region of the fibre around a guiding region of the fibre and arranged in a manner such that, in use, least leaking into a cladding region of the fibre around the Bragg region is experienced. in use, by the TE01 mode, whereby substantially only the TE01 mode is guided in the guiding region,

18. An method as claimed in claim 17, wherein the optical fibre comprises a photonic crystal fibre.

19. An method as claimed in claim 17, wherein the method further comprises the step of:
forming a central hole region in the optical fibre and arranged in a manner such that an effective refractive index for the HE11 mode of the optical signal is reduced to be equal to or below the refractive index of the cladding, whereby the HE11 mode is radiated away from the guiding region to assist suppressing guiding of the HE11 mode in the guiding region.

20. An method as claimed in claim 12, wherein the method comprises the steps of providing absorption means associated with the optical fibre and adapted to preferentially absorb light in modes other than the one non-degenerate mode.

21. An method as claimed in claim 20, wherein the method further, comprises the step of providing amplifying means associated with the optical fibre and adapted to amplify substantially only the one non-degenerate mode.

22. An method as claimed in claim 210, wherein the absorption means and/or an amplification means comprise regions of the optical fibre made from a suitable optically absorbing or amplifying material respectively.

23. A light source structure adapted in a manner such that it generates a light signal which comprises substantially only one non-degenerate mode.

24. A light source structure as claimed in claim 23, wherein the light source structure comprises an optical fibre laser, and wherein the optical fibre laser comprises an optical fibre as defined in any one of claims 1 to 10.

25. A method of generating a light signal which comprises substantially only one non-degenerate mode.

26. An method as claimed in claim 25, wherein the method comprises the step of effecting lasing to occur in an optical light source structure as defined in claims 23 or 24.
